(19) United States
(12) Patent Application Publication
(10) Pub. No.: US 2002/0059254 A1
(43) Pub. Date: May 16, 2002

(54) Method of managing personal information

(76) Inventors: Tsukasa Saito, Tokyo (JP); Shoichi Nakagawa, Saitama (JP); Nobuharu Miura, Urayasu (JP); Keiko Jono, Tokyo (JP); Shinsuke Honjo, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/975,264

(22) Filed: Oct. 12, 2001

(30) Foreign Application Priority Data
Oct. 12, 2000 (JP) 2000-311745

(51) Int. Cl. G06F 7/00

(52) U.S. Cl. 707/10

(57) ABSTRACT

An input for designating sent-out contents capable of being browsed on a provider-side processing apparatus is accepted. Ticket information for identifying a sending-party of sent-out contents is received from the provider-side processing apparatus. The sent-out contents and the ticket information are transmitted to a deliberation support processing apparatus to request a deliberation about the sent-out contents. The sent-out contents and the ticket information are stored into a deliberation managing database. An input of a deliberation result of the requested deliberation is accepted to store the deliberation result into the deliberation managing database. The ticket information is transmitted to a ticket management processing apparatus. Presentation of personal information on the sending-party is requested. The personal information on the sending-party identified by the ticket information is transmitted to the deliberation support processing apparatus. The deliberation result and the personal information on the sending-party are transmitted to the deliberation-requesting-party-side processing apparatus.

### BACKGROUND OF THE INVENTION

The present invention relates to a personal information managing system in the case of resolving an alternative dispute. More particularly, it relates to a technology that is effective when applied to a personal information managing system in the case of resolving a dispute, the dispute having occurred by the information such as a libel or a slander that had been sent out onto the Internet and publicized on an electronic bulletin board.

From conventionally, the sending-out of various information has been performed via networks such as the Internet. However, on some of the electronic bulletin boards where a large number of unspecified users have participated, or on some of the home pages that individuals have set up, the information with the following intentions is sometimes sent out. The libel, the slander, the defamation, and the privacy infringement toward a particular person or the like, and the infringement on an intellectual property right, and the like.

When the dispute has occurred by the information such as the libel or the slander sent out onto the Internet and publicized on the above-described electronic bulletin boards or home pages, the following steps are taken. First, based on a search warrant, the police requests the provider to execute the log (i.e., the communications record) analysis and the log submission for specifying the sending-party. Then, after specifying the sending-party who has sent out the information, the resolution is attempted by a trial.

Also, at present, an alternative dispute resolution (ADR) system for establishing a prompter and more flexible resolution system is now under examination with respect to a case that is taken into a civil lawsuit or a case against which no lawsuit is filed in silence with resignation. Consideration is now being given to applying the ADR system to the resolution of the dispute that has occurred by the information on the Internet.

Incidentally, in JP-A-10-275157, there has been described a data processing apparatus for reducing physical, mental, and financial burdens imposed on a user by the retrieval of an enormous amount of network information, and for avoiding the display or the translation of the unpleasant information such as the libel or the slander, and further, the information of violent content or obscene content judged not to be seen by children, and the like. Its summary is as follows. A characteristic data DB 1 for storing characteristic data indicating the characteristics of predetermined information, and a program are installed from, e.g., a CD-ROM, into the data processing apparatus where such a program as the browser operates, thereby causing the data processing apparatus to operate. Here, the program thus installed includes a characteristic data detecting unit for detecting whether or not the characteristic data has been included in the retrieved information, and a display controlling unit for prohibiting the display of the retrieved information by the retrieval displaying unit if the characteristic data has been included in the retrieved information.

As described above, when trying to resolve, by the trial, the dispute that has occurred by the information on the Internet, the sending-party who has sent out the information needs to be specified by the log analysis or the like. In some cases, however, the log has not been stored, or it is very difficult for the provider to specify the sending-party out of the enormous amount of log. This results in a problem that there occurs the case of being unable to specify the sending-party who has sent out the information that has become the cause of the dispute. Also, resolving the dispute by the trial results in a problem of costing so much and of necessitating an enormous amount of time and labor until the resolution. Also, the personal information on the immediately-concerned-parties is disclosed at the point-in-time of the prosecution (i.e., before the decision of being guilty is made). Accordingly, there exists a problem of abusing the personal information such as a personal revenge. Similarly, in the simple and prompt alternative dispute resolution system as well, the personal information is disclosed before the decision of an illegality. Consequently, there also exists the problem of abusing the personal information.

### SUMMARY OF THE INVENTION

It is an object of the present invention to provide a technology that can solve the above-described problems, can decrease the burden on the provider as to whether the disclosure of the personal information is appropriate or inappropriate and the risks between the immediately-concerned-parties, and can implement a simplified and high-reliability dispute resolution.

The present invention, which relates to the personal information managing system in the case of resolving a dispute that has occurred by the information sent out from an information processing apparatus, supports a deliberation for the dispute resolution where the personal information on the dispute-immediately-concerned-parties has been closed.

In the personal information managing system of the present invention, when a sending-party performs a writing-in onto an electronic bulletin board or a home page so as to try to send out the information, ticket information for identifying the sending-party is recorded in a state of being caused to correspond to his or her sent-out contents.

A deliberation-requesting-party has browsed the electronic bulletin board or the home page and has found out the information such as a libel or a slander, thus planning to request the deliberation based on the alternative dispute resolution system. From the provider that has managed the electronic bulletin board or the home page, the deliberation-requesting-party receives the presentation of the ticket information on the sending-party who has sent out the information, then requesting the deliberation about the sent-out contents together with the ticket information on the sending-party.

If making an inquiry of the sending-party becomes necessary in accompaniment with the deliberation about the sent-out contents the deliberation request for which has been made, a deliberation support processing apparatus on the alternative dispute resolving institution side requests a ticket management processing apparatus to make the inquiry together with the ticket information.

The ticket management processing apparatus makes reference to the personal information on the sending-party identified by the ticket information, and makes the requested inquiry to be made of the sending party identified by the ticket information. Then, the ticket management processing apparatus sends back a reply from the sending-party on the inquiry to the deliberation support processing apparatus.

Also, if the sent-out contents has been judged to be illegal by the deliberation at the alternative dispute resolving institution, the deliberation support processing apparatus on the alternative dispute resolving institution side requests the ticket management processing apparatus to present the personal information on the sending-party identified by the ticket information. Then, the deliberation support processing apparatus receives the presentation of the personal information on the sending-party from the ticket management processing apparatus. Moreover, the deliberation support processing apparatus discloses the presented personal information on the sending-party to the deliberation-requesting-party, i.e., the aggrieved-party. Otherwise, the deliberation support processing apparatus presents, to the deliberation-requesting-party and the sending-party identified by the presentation of the personal information, a resolving-proposal for the dispute that has occurred by the information, thereby attempting to resolve the dispute.

As described above, the present invention makes it possible to execute, on the condition of the anonymity, the deliberation about the sent-out contents sent out from the information processing apparatus. As a consequence, the provider owning the personal information on the sending-party need not make the judgement on whether the disclosure of the personal information on the sending-party is appropriate or inappropriate, and the alternative dispute resolution system provides the simplified and high-reliability dispute resolution. This makes it possible to decrease the silent-resignation no-lawsuit-filing cases. Also, as long as there exists no illegality in the deed, the personal information is closed. This prevents the personal revenge and decreases the risks between the immediately-concerned-parties, thereby making it possible to promote the utilization of the alternative dispute resolution system.

As having been described so far, the personal information managing system of the present invention supports the deliberation for the dispute resolution where the personal information on the dispute-immediately-concerned-parties has been closed. Accordingly, it becomes possible to decrease the burden on the provider as to whether the disclosure of the personal information is appropriate or inappropriate and the risks between the immediately-concerned parties, thereby allowing the simplified and high-reliability dispute resolution to be implemented.

### BRIEF DESCRIPTION OF THE DRAWINGS

FIG. 1 is a diagram for illustrating the schematic configuration of a personal information managing system in the present embodiment;

FIG. 2 is a diagram for illustrating the schematic configuration of a deliberation support processing apparatus 100 in the present embodiment;

FIG. 3 is a diagram for illustrating the schematic configuration of a sending-party-side processing apparatus 101 in the present embodiment;

FIG. 4 is a diagram for illustrating the schematic configuration of a provider-side processing apparatus 102 in the present embodiment;

FIG. 5 is a diagram for illustrating the schematic configuration of a ticket management processing apparatus 103 in the present embodiment;

FIG. 6 is a diagram for illustrating the schematic configuration of a deliberation-requesting-party-side processing apparatus 104 in the present embodiment;

FIG. 7 is a diagram for illustrating the outline of an information-sending process in the present embodiment;

FIG. 8 is a diagram for illustrating one example of a personal information DB 509 in the present embodiment;

FIG. 9 is a flow chart for illustrating the processing steps of the information-sending process in the present embodiment;

FIG. 10 is a flow chart for illustrating the processing steps of a ticket-issuing process in the present embodiment;

FIG. 11 is a diagram for illustrating one example of a sending-party ticket 308 in the present embodiment;

FIG. 12 is a flow chart for illustrating the processing steps of an information-sending accepting process in the present embodiment;

FIG. 13 is a diagram for illustrating one example of provider access policy information 408 in the present embodiment;

FIG. 14 is a diagram for illustrating one example of a sent-out content managing DB 409 in the present embodiment;

FIG. 15 is a flow chart for illustrating the processing steps of a deliberation requesting process in the present embodiment;

FIG. 16 is a flow chart for illustrating the processing steps of a ticket information presenting process in the present embodiment;

FIG. 17 is a flow chart for illustrating the processing steps of a deliberation accepting process in the present embodiment;

FIG. 18 is a diagram for illustrating one example of a deliberation managing DB 209 in the present embodiment;

FIG. 19 is a flow chart for illustrating the processing steps of an inquiry requesting process in the present embodiment;

FIG. 20 is a flow chart for illustrating the processing steps of an inquiring process in the present embodiment;

FIG. 21 is a flow chart for illustrating the processing steps of a deliberation result informing process in the present embodiment; and

FIG. 22 is a flow chart for illustrating the processing steps of a personal information presenting process in the present embodiment.

### DETAILED DESCRIPTION OF THE EMBODIMENTS

Hereinafter, the explanation will be given below concerning an embodiment of a personal information managing system for resolving a dispute, the dispute having occurred by the information such as a libel or a slander that had been sent out onto the Internet and publicized on an electronic bulletin board.

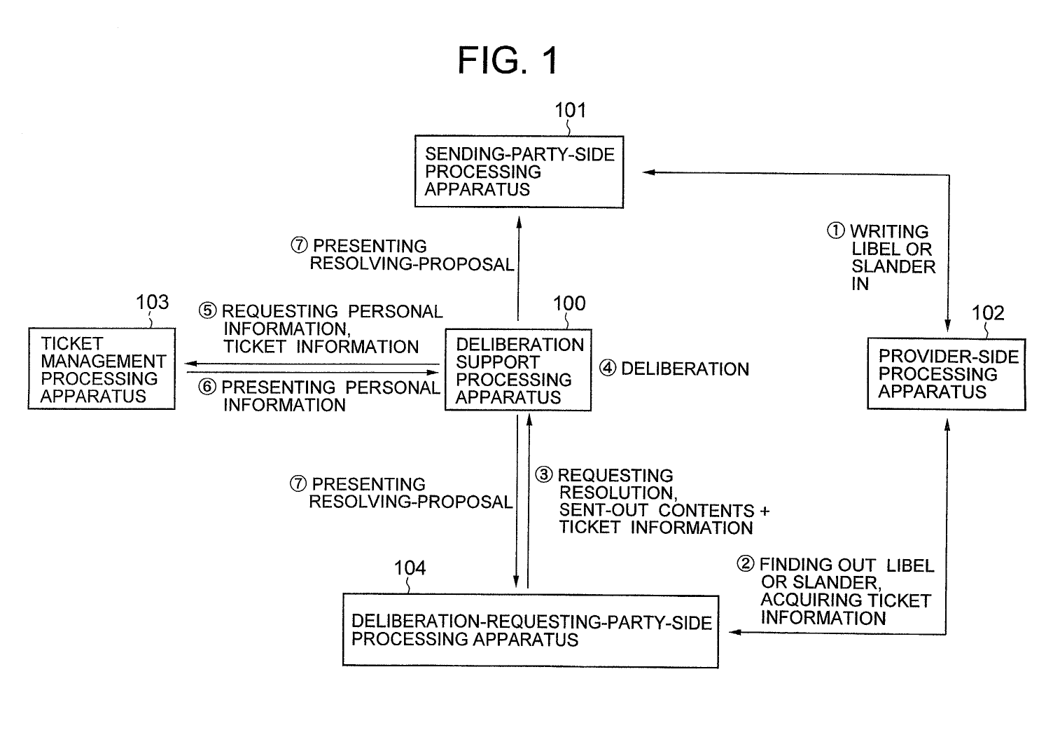

FIG. 1 is a diagram for illustrating the schematic configuration of the personal information managing system in the present embodiment. As illustrated in FIG. 1, the personal information managing system in the present embodiment includes a deliberation support processing apparatus 100, a sending-party-side processing apparatus 101, a provider-side processing apparatus 102, a ticket management processing apparatus 103, and a deliberation-requesting-party-side processing apparatus 104.

The deliberation support processing apparatus 100 is a processing apparatus on an alternative dispute resolving institution side. With the anonymity of the immediately-concerned-parties being maintained; the alternative dispute resolving institution executes a deliberation as to whether or not the sent-out contents are the information including an illegality such as a libel or a slander toward a particular person, thereby resolving the alternative dispute. Here, the sent-out contents have been sent out from an electronic bulletin board or a home page that is freely browse-capable via networks.

The sending-party-side processing apparatus 101 is a processing apparatus on a sending-party side. The sending-party uploads text data, image data, motion-picture data, voice data, or the like onto the electronic bulletin board or the home page provided by a provider or the like, thereby sending out the various types of information.

The provider-side processing apparatus 102 is a processing apparatus on the provider side. The provider provides the electronic bulletin board or the home page that stores the various types of information uploaded by the sending-party and that is freely browse-capable via the networks such as the Internet.

The ticket management processing apparatus 103 is a processing apparatus on a trustworthy third party institution side. The third party institution manages the employment and utilization of the tickets for making it possible to maintain the secrecy of the personal information, to specify the personal information as required, and to perform the various types of access controls using a disclosed portion of the personal information. The deliberation-requesting-party-side processing apparatus 104 is a processing apparatus on a deliberation-requesting-party side. The deliberation-requesting-party requests the alternative dispute resolving institution to execute the deliberation as to whether or not the sent-out contents sent out from the electronic bulletin board or the home page includes the illegality.

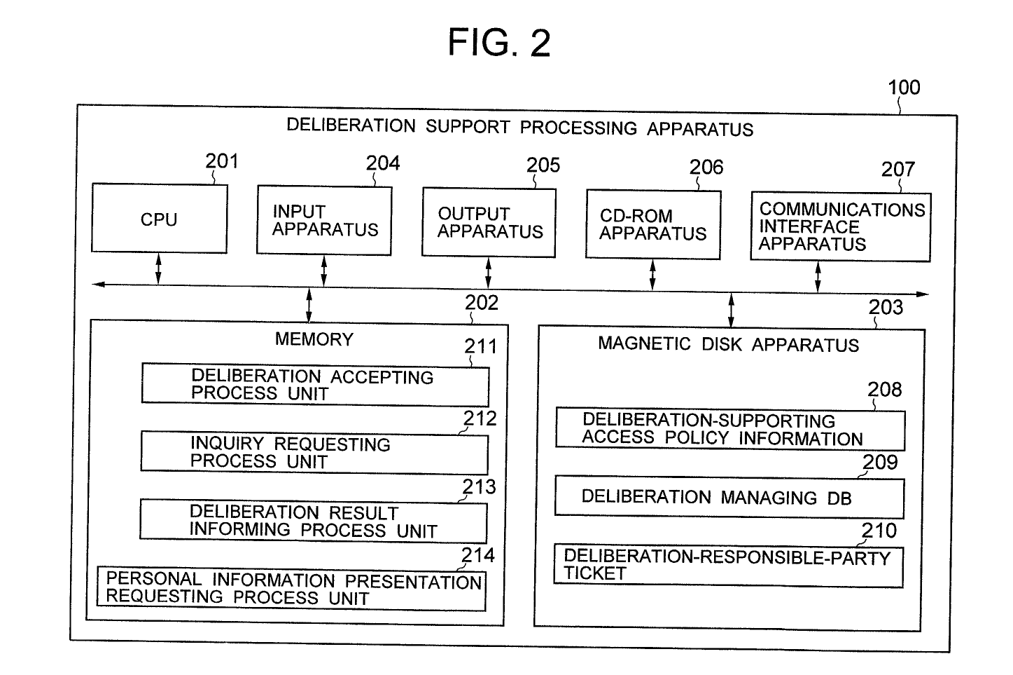

FIG. 2 is a diagram for illustrating the schematic configuration of the deliberation support processing apparatus 100 in the present embodiment. As illustrated in FIG. 2, the deliberation support processing apparatus 100 in the present embodiment includes a CPU 201, a memory 202, a magnetic disk apparatus 203, an input apparatus 204, an output apparatus 205, a CD-ROM apparatus 206, a communications interface apparatus 207, a deliberation-supporting access policy information 208, a deliberation managing DB 209, and a deliberation-responsible-party ticket 210.

The CPU 201 is an apparatus for controlling the operation of the deliberation support processing apparatus 100 as a whole. The memory 202 is a memory apparatus that, when controlling the operation of the deliberation support processing apparatus 100 as a whole, loads the various types of processing programs or data therefor.

The magnetic disk apparatus 203 is a memory apparatus for storing the above-described various types of processing programs or data. The input apparatus 204 is an apparatus for performing the various types of inputs for supporting the deliberation at the alternative dispute resolving institution. The output apparatus 205 is an apparatus for performing the various types of outputs accompanying the support for the deliberation at the alternative dispute resolving institution.

The CD-ROM apparatus 206 is an apparatus for reading out the contents of a CD-ROM storing the above-described various types of processing programs. The communications interface apparatus 207 is an apparatus for establishing communications with the other processing apparatuses via the networks such as an intranet and the Internet.

The deliberation-supporting access policy information 208 is information indicating a condition that permits the deliberation support processing apparatus 100 to accept the deliberation request. The deliberation managing DB 209 is a database for storing information indicating the contents of the deliberation accepted from the deliberation-requesting-party-side processing apparatus 104.

The deliberation-responsible-party ticket 210 is data that stores a ticket ID for identifying personal information on the deliberation-responsible-party, and that stores which of the personal information on the deliberation-responsible-party has been approved and disclosed by the ticket management processing apparatus 103.

The deliberation support processing apparatus 100 also includes a deliberation accepting process unit 211, an inquiry requesting process unit 212, a deliberation result informing process unit 213, and a personal information presentation requesting process unit 214.

The deliberation accepting process unit 211 is a processing unit for receiving the sent-out contents becoming the target of the deliberation, ticket information in a sending-party ticket, and a deliberation-requesting-party ticket from the deliberation-requesting-party-side processing apparatus 104, and for storing them into the deliberation managing DB 209.

The inquiry requesting process unit 212 is a processing unit for accepting the input of the inquiry contents to be made of the sending-party so as to store the inquiry contents into the deliberation managing DB 209, and for transmitting the inquiry contents and the ticket information, which are stored into the deliberation managing DB 209, from the deliberation support processing apparatus 100 to the ticket management processing apparatus 103.

The deliberation result informing process unit 213 is a processing unit for transmitting a deliberation result which is stored into the deliberation managing DB 209, and personal information on the sending-party which is received from the ticket management processing apparatus 103, from the deliberation support processing apparatus 100 to the deliberation-requesting-party-side processing apparatus 104.

The personal information presentation requesting process unit 214 is a processing unit for accepting the input of the deliberation result of the requested deliberation so as to store the deliberation result into the deliberation managing DB 209, and for transmitting the ticket information, which is stored into the deliberation managing DB 209, from the deliberation support processing apparatus 100 to the ticket management processing apparatus 103 so as to request the presentation of the personal information on the sending-party.

A program for causing the deliberation support processing apparatus 100 to function as the deliberation accepting process unit 211, the inquiry requesting process unit 212, the deliberation result informing process unit 213, and the personal information presentation requesting process unit 214 is recorded into a record medium such as the CD-ROM and stored into the magnetic disk or the like. After that, the program is loaded onto the memory, then being executed. Incidentally, the record medium for recording the above-described program may be another record medium other than the CD-ROM.

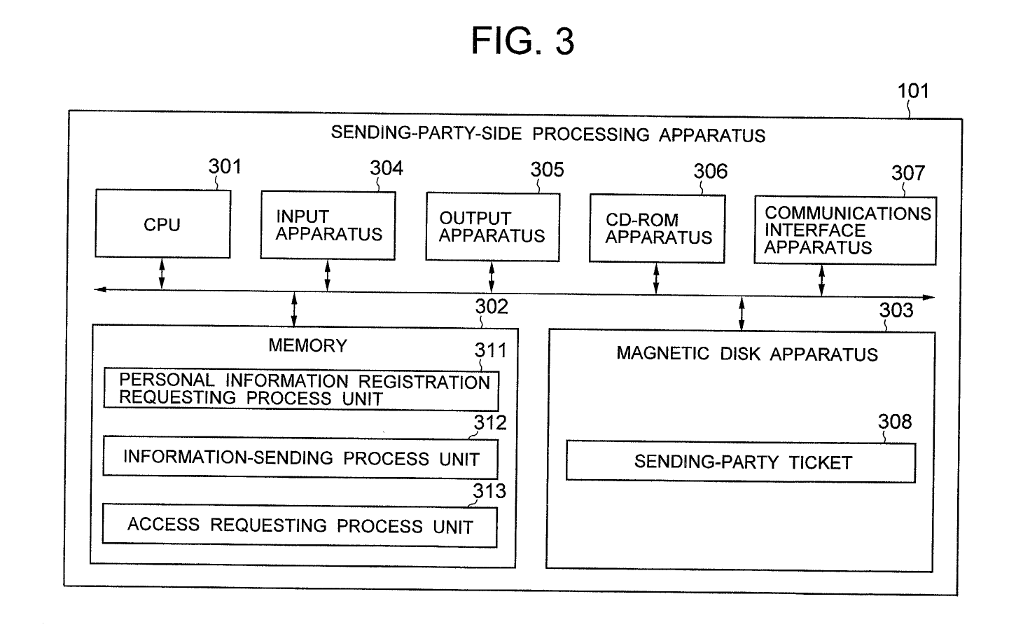

FIG. 3 is a diagram for illustrating the schematic configuration of the sending-party-side processing apparatus 101 in the present embodiment. As illustrated in FIG. 3, the sending-party-side processing apparatus 101 in the present embodiment includes a CPU 301, a memory 302, a magnetic disk apparatus 303, an input apparatus 304, an output apparatus 305, a CD-ROM apparatus 306, a communications interface apparatus 307, and the sending-party ticket 308.

The CPU 301 is an apparatus for controlling the operation of the sending-party-side processing apparatus 101 as a whole. The memory 302 is a memory apparatus that, when controlling the operation of the sending-party-side processing apparatus 101 as a whole, loads the various types of processing programs or data therefor.

The magnetic disk apparatus 303 is a memory apparatus for storing the above-described various types of processing programs or data. The input apparatus 304 is an apparatus for performing the various types of inputs for executing the information-sending to the provider-side processing apparatus 102. The output apparatus 305 is an apparatus for performing the various types of outputs accompanying the information-sending to the provider-side processing apparatus 102.

The CD-ROM apparatus 306 is an apparatus for reading out the contents of the CD-ROM storing the above-described various types of processing programs. The communications interface apparatus 307 is an apparatus for establishing communications with the other processing apparatuses via the networks such as an intranet and the Internet. The sending-party ticket 308 is data that stores a ticket ID for identifying the personal information on the sending-party, and that stores which of the personal information on the sending-party has been approved and disclosed by the ticket management processing apparatus 103.

The sending-party-side processing apparatus 101 also includes a personal information registration requesting process unit 311, an information-sending process unit 312, and an access requesting process unit 313.

The personal information registration requesting process unit 311 is a processing unit for requesting the ticket management processing apparatus 103 to register the personal information on the sending-party. The information-sending process unit 312 is a processing unit for accepting the input of the sent-out contents such as text data, image data, motion-picture data, and voice data, and for uploading the sent-out contents onto the electronic bulletin board or the home page inside the provider-side processing apparatus 102 so as to send out the various types of information.

The access requesting process unit 313 is a processing unit for acquiring, from the ticket management processing apparatus 103, the sending-party ticket 308 needed for the access to the electronic bulletin board or the home page inside the provider-side processing apparatus 102, and for transmitting the sending-party ticket together with the sent-out contents so as to request the access to the provider-side processing apparatus 102.

A program for causing the sending-party-side processing apparatus 101 to function as the personal information registration requesting process unit 311, the information-sending process unit 312, and the access requesting process unit 313 is recorded into a record medium such as the CD-ROM and stored into the magnetic disk or the like. After that, the program is loaded onto the memory, then being executed. Incidentally, the record medium for recording the above-described program may be another record medium other than the CD-ROM.

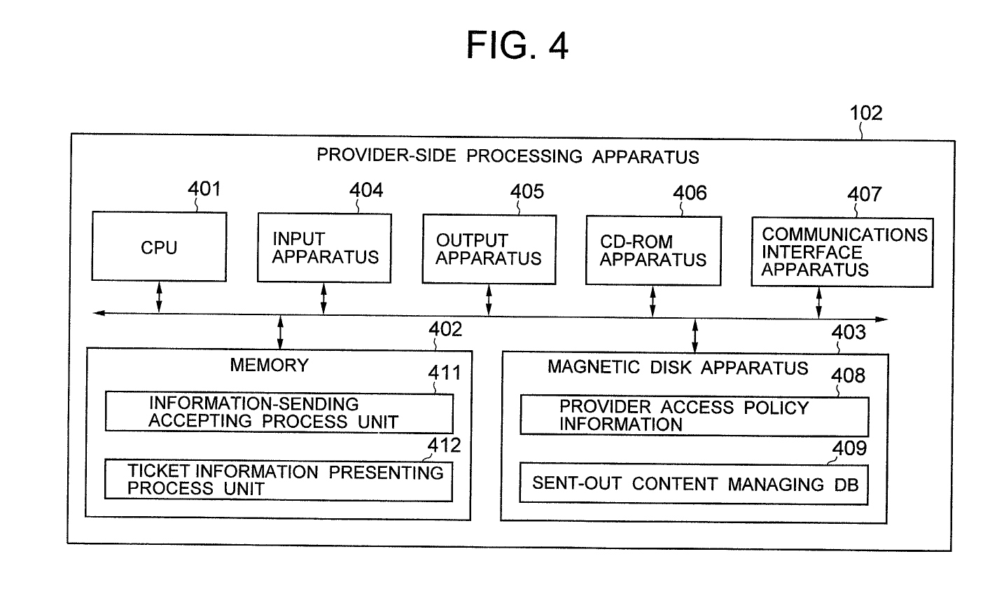

FIG. 4 is a diagram for illustrating the schematic configuration of the provider-side processing apparatus 102 in the present embodiment. As illustrated in FIG. 4, the provider-side processing apparatus 102 in the present embodiment includes a CPU 401, a memory 402, a magnetic disk apparatus 403, an input apparatus 404, an output apparatus 405, a CD-ROM apparatus 406, a communications interface apparatus 407, provider access policy information 408, and a sent-out content managing DB 409.

The CPU 401 is an apparatus for controlling the operation of the provider-side processing apparatus 102 as a whole. The memory 402 is a memory apparatus that, when controlling the operation of the provider-side processing apparatus 102 as a whole, loads the various types of processing programs or data therefor.

The magnetic disk apparatus 403 is a memory apparatus for storing the above-described various types of processing programs or data. The input apparatus 404 is an apparatus for performing the various types of inputs for receiving the sent-out content from the sending-party-side processing apparatus 101. The output apparatus 405 is an apparatus for performing the various types of outputs accompanying the reception of the sent-out contents from the sending-party-side processing apparatus 101.

The CD-ROM apparatus 406 is an apparatus for reading out the contents of the CD-ROM storing the above-described various types of processing programs. The communications interface apparatus 407 is an apparatus for establishing communications with the other processing apparatuses via the networks such as an intranet and the Internet.

The provider access policy information 408 is information indicating a condition that permits the access to the electronic bulletin board or the home page inside the provider-side processing apparatus 102. The sent-out content managing DB 409 is a database for managing the sent-out contents and the ticket information in a state of being caused to correspond to each other, the sent-out contents having been transmitted from the sending-party-side processing apparatus 101 and having become freely browse-capable at the provider-side processing apparatus 102, the ticket information being provided for identifying the sending-party who has transmitted the sent-out contents to the provider-side processing apparatus 102.

The provider-side processing apparatus 102 also includes an information-sending accepting process unit 411 and a ticket information presenting process unit 412.

The information-sending accepting process unit 411 is a processing unit for accepting, from the sending-party-side processing apparatus 101, the various types of information on the sending-party satisfying the condition indicated by the provider access policy information 408, and for storing the various types of information into the area of the electronic bulletin board or the home page that is freely browse-capable via the networks such as the Internet.

The ticket information presenting process unit 412 is a processing unit for accepting, from the deliberation-requesting-party-side processing apparatus 104, the presentation request for the ticket information on the sent-out contents that has become freely browse-capable on the electronic bulletin board or the home page, and for reading out, from the sent-out content managing DB 409, the ticket information corresponding to the sent-out contents so as to present the ticket information to the deliberation-requesting-party-side processing apparatus 104.

A program for causing the provider-side processing apparatus 102 to function as the information-sending accepting process unit 411 and the ticket information presenting process unit 412 is recorded into a record medium such as the CD-ROM and stored into the magnetic disk or the like. After that, the program is loaded onto the memory, then being executed. Incidentally, the record medium for recording the above-described program may be another record medium other than the CD-ROM.

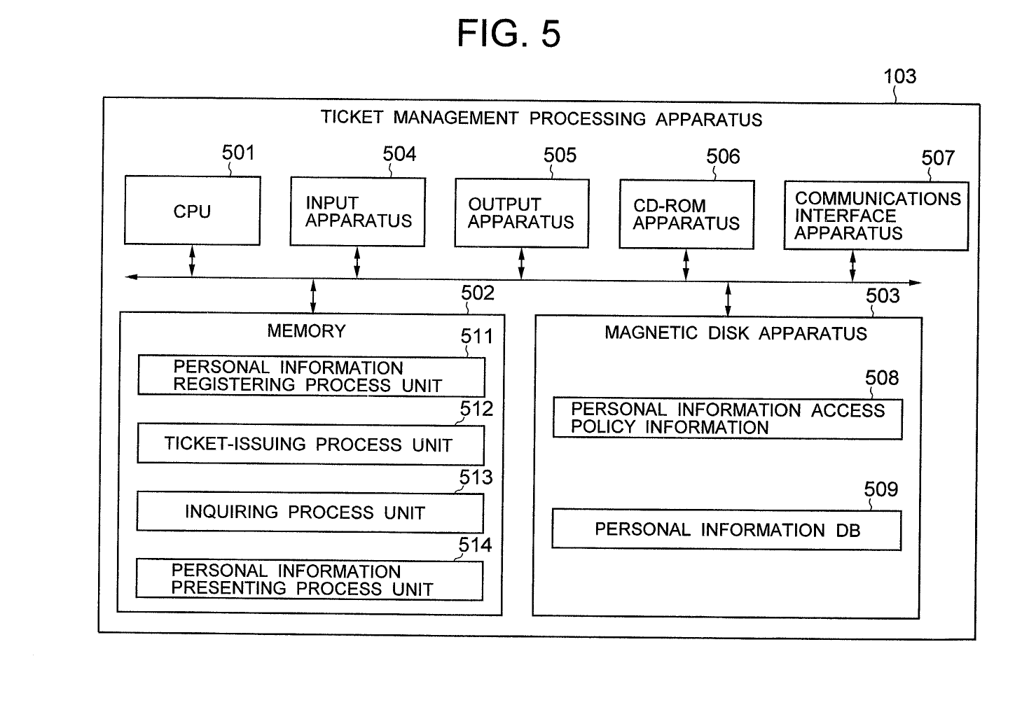

FIG. 5 is a diagram for illustrating the schematic configuration of the ticket management processing apparatus 103 in the present embodiment. As illustrated in FIG. 5, the ticket management processing apparatus 103 in the present embodiment includes a CPU 501, a memory 502, a magnetic disk apparatus 503, an input apparatus 504, an output apparatus 505, a CD-ROM apparatus 506, a communications interface apparatus 507, a personal information access policy information 508, and a personal information DB 509.

The CPU 501 is an apparatus for controlling the operation of the ticket management processing apparatus 103 as a whole. The memory 502 is a memory apparatus that, when controlling the operation of the ticket management processing apparatus 103 as a whole, loads the various types of processing programs or data therefor.

The magnetic disk apparatus 503 is a memory apparatus for storing the above-described various types of processing programs or data. The input apparatus 504 is an apparatus for performing the various types of inputs for managing the personal information on the users so as to issue the tickets needed for the accesses to the respective processing apparatuses.

The output apparatus 505 is an apparatus for performing the various types of outputs that accompany the issuing of the tickets needed for the management of the personal information on the users and the accesses to the respective processing apparatuses. The CD-ROM apparatus 506 is an apparatus for reading out the contents of the CD-ROM storing the above-described various types of processing programs. The communications interface apparatus 507 is an apparatus for establishing communications with the other processing apparatuses via the networks such as an intranet and the Internet. The personal information access policy information 508 is information indicating a condition for accepting the presentation request for the personal information stored into the personal information DB 509 in the ticket management processing apparatus 103. The personal information DB 509 is a database for storing the personal information on the users who wish to use the tickets for maintaining the secrecy of the personal information and performing the various types of access controls.

The ticket management processing apparatus 103 also includes a personal information registering process unit 511, a ticket-issuing process unit 512, an inquiring process unit 513, and a personal information presenting process unit 514.

The personal information registering process unit 511 is a processing unit for accepting the registration request for the personal information from the processing apparatus such as the sending-party-side processing apparatus 101, and for registering, into the personal information DB 509, the personal information on the users who wish to use the tickets. The ticket-issuing process unit 512 is a processing unit for accepting a ticket-issuing request from a user who has registered his or her personal information, and for issuing the ticket of the user.

The inquiring process unit 513 is a processing unit for receiving the inquiry contents and the ticket information from the deliberation support processing apparatus 100, for making reference to a mail address indicated in a contact address in the personal information identified by the ticket information, and for transmitting the inquiry contents from the ticket management processing apparatus 103 to the mail address.

The personal information presenting process unit 514 is a processing unit for receiving the ticket information from the deliberation support processing apparatus 100 satisfying the condition indicated by the personal information access policy information 508, and for transmitting, from the ticket management processing apparatus 103 to the deliberation support processing apparatus 100, the personal information on the sending-party identified by the ticket information.

A program for causing the ticket management processing apparatus 103 to function as the personal information registering process unit 511, the ticket-issuing process unit 512, the inquiring process unit 513, and the personal information presenting process unit 514 is recorded into a record medium such as the CD-ROM and stored into the magnetic disk or the like. After that, the program is loaded onto the memory, then being executed. Incidentally, the record medium for recording the above-described program may be another record medium other than the CD-ROM.

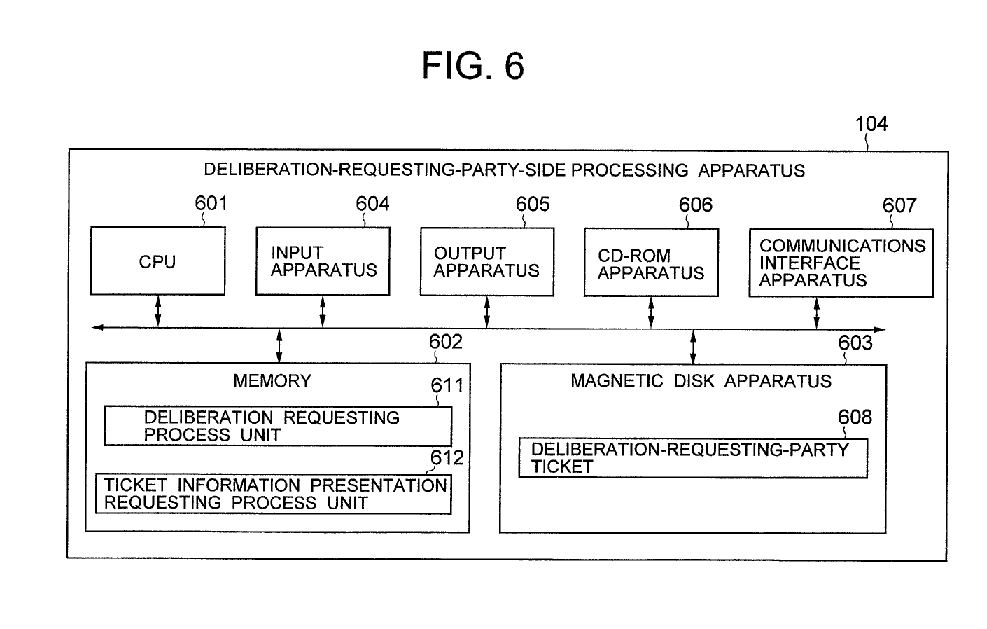

FIG. 6 is a diagram for illustrating the schematic configuration of the deliberation-requesting-party-side processing apparatus 104 in the present embodiment. As illustrated in FIG. 6, the deliberation-requesting-party-side processing apparatus 104 in the present embodiment includes a CPU 601, a memory 602, a magnetic disk apparatus 603, an input apparatus 604, an output apparatus 605, a CD-ROM apparatus 606, a communications interface apparatus 607, and a deliberation-requesting-party ticket 608.

The CPU 601 is an apparatus for controlling the operation of the deliberation-requesting-party-side processing apparatus 104 as a whole. The memory 602 is a memory apparatus that, when controlling the operation of the deliberation-requesting-party-side processing apparatus 104 as a whole, loads the various types of processing programs or data therefor.

The magnetic disk apparatus 603 is a memory apparatus for storing the above-described various types of processing programs or data. The input apparatus 604 is an apparatus for performing the various types of inputs for requesting the deliberation concerning the sent-out contents. The output apparatus 605 is an apparatus for performing the various types of outputs that accompany the request for the deliberation concerning the sent-out contents.

The CD-ROM apparatus 606 is an apparatus for reading out the contents of the CD-ROM storing the above-described various types of processing programs. The communications interface apparatus 607 is an apparatus for establishing communications with the other processing apparatuses via the networks such as an intranet and the Internet.

The deliberation-requesting-party ticket 608 is data that stores a ticket ID for identifying personal information on the deliberation-requesting-party, and that stores which of the personal information on the deliberation-requesting-party has been approved and disclosed by the ticket management processing apparatus 103.

The deliberation-requesting-party-side processing apparatus 104 also includes a deliberation requesting process unit 611 and a ticket information presentation requesting process unit 612.

The deliberation requesting process unit 611 is a processing unit for accepting the input of designating the sent-out contents that have become freely browse-capable on the electronic bulletin board or the home page on the provider-side processing apparatus 102 connected thereto via the networks, and for receiving, from the provider-side processing apparatus 102, the ticket information for identifying the sending-party who has sent out the designated sent-out contents, and for transmitting the sent-out contents and the ticket information from the deliberation-requesting-party-side processing apparatus 104 to the deliberation support processing apparatus 100 so as to request the deliberation about the sent-out contents. The ticket information presentation requesting process unit 612 is a processing unit for requesting the provider-side processing apparatus 102 to present the ticket information in the sending-party ticket 308 corresponding to the sent-out contents.

A program for causing the deliberation-requesting-party-side processing apparatus 104 to function as the deliberation requesting process unit 611 and the ticket information presentation requesting process unit 612 is recorded into a record medium such as the CD-ROM and stored into the magnetic disk or the like. After that, the program is loaded onto the memory, then being executed. Incidentally, the record medium for recording the above-described program may be another record medium other than the CD-ROM.

Hereinafter, the explanation will be given below concerning the processing where, in the personal information managing system in the present embodiment, the sent-out contents such as text data, image data, motion-picture data, and voice data, and its sending-party's ticket are transmitted to the provider-side processing apparatus 102 so as to send out the various types of information via the networks such as the Internet.

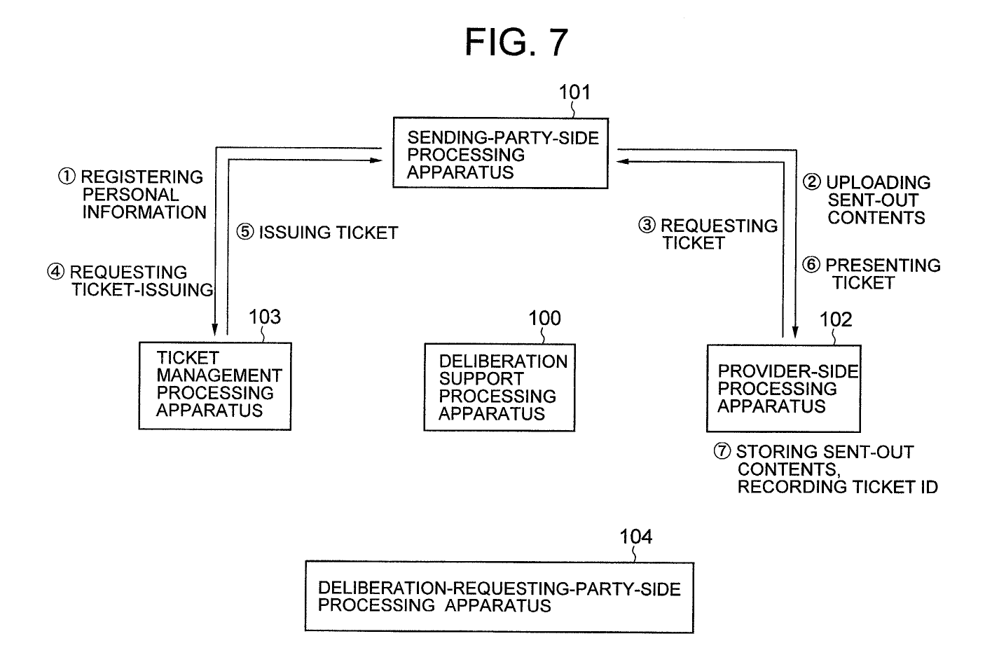

FIG. 7 is a diagram for illustrating the outline of the information-sending process in the present embodiment. As illustrated in FIG. 7, in the present embodiment, when uploading the sent-out contents onto the electronic bulletin board or the home page in the provider-side processing apparatus 102 so as to perform the information-sending, the personal information is registered into the ticket management processing apparatus 103 in advance. Then, if the provider-side processing apparatus 102 requests the ticket at the time of the uploading of the sent-out contents, the ticket is acquired from the ticket management processing apparatus 103 so as to be transmitted to the provider-side processing apparatus 102, thereby obtaining the permission to execute the uploading. Also, the sent-out contents and the ticket ID (i.e., the ticket information) are recorded into the provider-side processing apparatus 102 in a state of being caused to correspond to each other.

In the personal information managing system in the present embodiment, in some cases, making the accesses to the respective processing apparatuses connected to the networks necessitates the presentation of the tickets. Accordingly, prior to the accesses to the respective processing apparatuses, the users register the personal information into the ticket management processing apparatus 103 in advance.

Namely, the sending-party who tries to perform the writing-in onto the electronic bulletin board or the home page in the provider-side processing apparatus 102 so as to send out the various types of information performs, by the personal information registration requesting process unit 311 in the sending-party-side processing apparatus 101, the processing of requesting the ticket management processing apparatus 103 to register the personal information on the sending-party. The personal information registering process unit 511 in the ticket management processing apparatus 103 performs the processing of accepting the registration request for the personal information from the processing apparatus such as the sending-party-side processing apparatus 101, and of registering, into the personal information DB 509, the personal information on the users who wish to use the tickets.

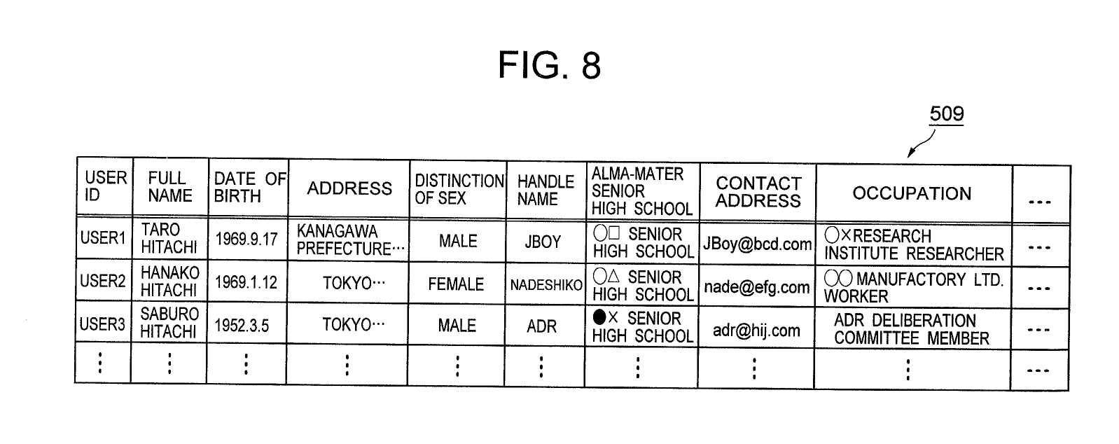

FIG. 8 is a diagram for illustrating one example of the personal information DB 509 in the present embodiment. As illustrated in FIG. 8, the personal information DB 509 in the ticket management processing apparatus 103 has stored the personal information on the users who wish the use of the tickets for maintaining the secrecy of the personal information and performing the various types of access controls.

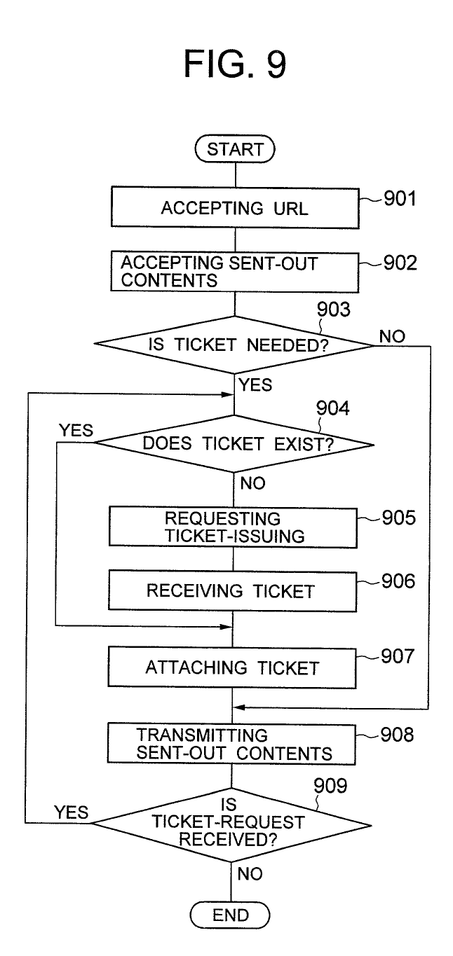

FIG. 9 is a flow chart for illustrating the processing steps of the information-sending process in the present embodiment. As illustrated in FIG. 9, the information-sending process unit 312 in the sending-party-side processing apparatus 101 accepts the input of the sent-out content such as text data, image data, motion-picture data, and voice data, and uploads the sent-out contents onto the electronic bulletin board or the home page inside the provider-side processing apparatus 102 so as to send out the various types of information. The access requesting process unit 313 acquires, from the ticket management processing apparatus 103, the sending-party ticket 308 needed for the access to the electronic bulletin board or the home page inside the provider-side processing apparatus 102, and transmits the sending-party ticket together with the sent-out contents so as to request the access to the provider-side processing apparatus 102.

At a step 901, the information-sending process unit 312 in the sending-party-side processing apparatus 101 accepts, from the sending-party, the input of the URL (i.e., Uniform Resource Locators) of the electronic bulletin board or the home page inside the provider-side processing apparatus 102 so as to make the access to the provider-side processing apparatus 102 via the networks. At a step 902, the information-sending process unit 312 accepts the input of the sent-out contents that the sending-party is going to send out.

At a step 903, the access requesting process unit 313 checks whether or not the previously-received provider access policy information 408 exists inside the magnetic disk apparatus 303 in the sending-party-side processing apparatus 101, thereby judging whether or not the ticket is needed at the time of uploading the various types of information onto the electronic bulletin board or the home page inside the provider-side processing apparatus 102. If the ticket is needed, the processing goes to a step 904.

At the step 904, it is checked whether or not the sending-party ticket 308 that is valid at the time of the access to the electronic bulletin board or the home page inside the provider-side processing apparatus 102 has been stored in a predetermined directory inside the magnetic disk apparatus 303 in the sending-party-side processing apparatus 101. If the sending-party ticket 308 does not exist, the processing goes to a step 905.

At the step 905, the user ID of the sending-party and the provider access policy information 408 are transmitted to the ticket management processing apparatus 103 via the networks, thereby requesting the issuing of the ticket.

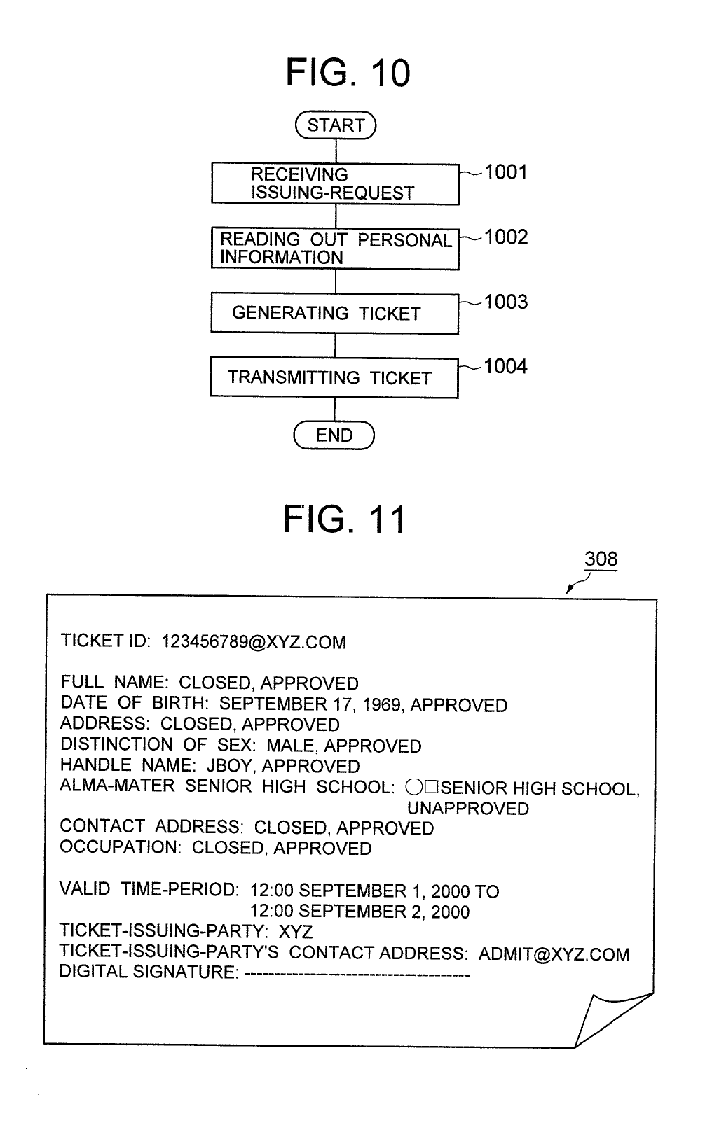

FIG. 10 is a flow chart for illustrating the processing steps of the ticket-issuing process in the present embodiment. As illustrated in FIG. 10, the ticket-issuing process unit 512 in the ticket management processing apparatus 103 accepts a ticket-issuing request from a user who has registered his or her personal information, and issues the ticket of the user.

At a step 1001, the ticket-issuing process unit 512 in the ticket management processing apparatus 103 accepts the issuing request for the ticket including the user ID of the user and the provider access policy information 408, from the processing apparatus such as the sending-party-side processing apparatus 101 via the networks.

At a step 1002, information needed in the provider access policy information 408 out of the personal information on the user who has performed the ticket-issuing request is read out from the personal information DB 509. At a step 1003, the ticket is generated based on the above-described read-out personal information. At a step 1004, the generated ticket is transmitted to the requesting source such as the sending-party-side processing apparatus 101 that has performed the ticket-issuing request.

FIG. 11 is a diagram for illustrating one example of the sending-party ticket 308 in the present embodiment. As illustrated in FIG. 11, the sending-party ticket 308 in the sending-party-side processing apparatus 101 has stored the ticket ID for identifying the personal information on the sending-party; the full name, the date of birth, the address, the distinction of sex, the handle name, the alma-mater senior high school, the contact address, and the occupation of the sending-party; the valid time-period; the ticket-issuing-party; the ticket-issuing-party's contact address; the digital signature, and the like. Concerning the full name, the date of birth, the address, the distinction of sex, the handle name, the alma-mater senior high school, the contact address, and the occupation of the sending-party, it is pointed out whether or not these information have been approved by the ticket-issuing-party.

At a step 906 illustrated in FIG. 9, the access requesting process unit 313 in the sending-party-side processing apparatus 101 receives the ticket issued from the ticket management processing apparatus 103, and stores the ticket as the sending-party ticket 308 into the predetermined directory inside the magnetic disk apparatus 303.

At a step 907, the sending-party ticket 308 is attached to the above-described inputted sent-out contents. At a step 908, the sent-out contents to which the sending-party ticket 308 has been attached is transmitted to the provider-side processing apparatus 102.

Also, in the case where, as the result of the checking performed at the step 903, the provider access policy information 408 does not exist inside the magnetic disk apparatus 303 in the sending-party-side processing apparatus 101, the ticket is judged to be unnecessary at the time of the access to the provider-side processing apparatus 102. Thus, at the step 908, the sent-out contents to which the sending-party ticket 308 has been not attached is transmitted to the provider-side processing apparatus 102.

At a step 909, the response contents to the above-described sent-out contents from the provider-side processing apparatus 102 are examined. Then, in the case where a ticket-requesting message has been received as the response to the transmission of the sent-out contents to which the sending-party ticket 308 has been not attached, the provider access policy information 408 transmitted together with the message is stored into the magnetic disk apparatus 303 in the sending-party-side processing apparatus 101. After that, the processing subsequent to the step 904 is performed, thereby transmitting, to the provider-side processing apparatus 102, the sent-out contents to which the sending-party ticket 308 has been attached.

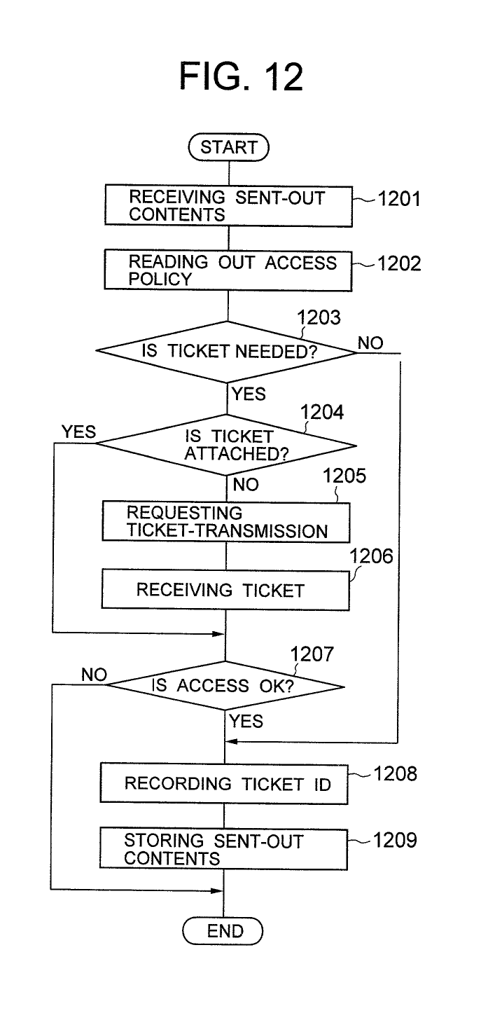

FIG. 12 is a flow chart for illustrating the processing steps of the information-sending accepting process in the present embodiment. As illustrated in FIG. 12, the information-sending accepting process unit 411 in the provider-side processing apparatus 102 accepts, from the sending-party-side processing apparatus 101, the various types of information on the sending-party satisfying the condition indicated by the provider access policy information 408, and stores the various types of information into the area of the electronic bulletin board or the home page that is freely browse-capable via the networks such as the Internet.

At a step 1201, the information-sending accepting process unit 411 in the provider-side processing apparatus 102 receives the sent-out contents, which the sending-party is going to send out, from the sending-party-side processing apparatus 101 via the networks. Then, the processing goes to a step 1202.

At the step 1202, the provider access policy information 408 stored in the magnetic disk apparatus 403 in the provider-side processing apparatus 102 is read out. At a step 1203, it is checked whether or not the provider access policy information 408 has indicated that the sending-party ticket 308 is needed when the above-described received sent-out contents are stored into the area of the electronic bulletin board or the home page that is freely browse-capable via the networks such as the Internet. If the sending-party ticket 308 is needed, the processing goes to a step 1204.

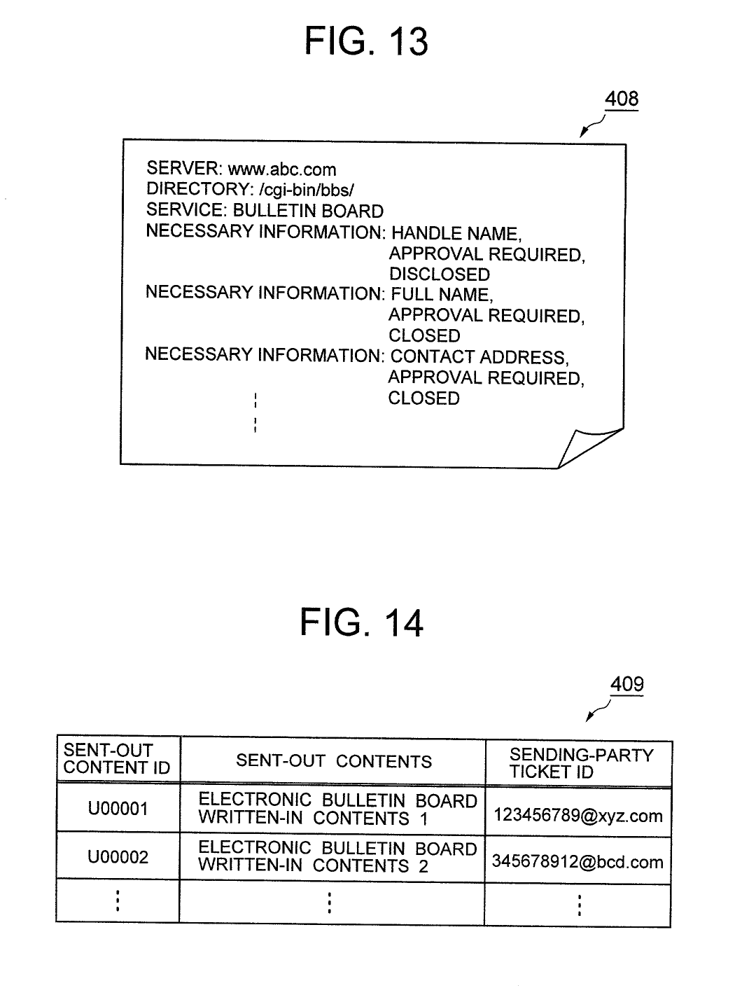

FIG. 13 is a diagram for illustrating one example of the provider access policy information 408 in the present embodiment. As illustrated in FIG. 13, the provider access policy information 408 in the provider-side processing apparatus 102 has indicated the information in the sending-party ticket 308 that becomes necessary when giving the permission to the access to the electronic bulletin board inside the provider-side processing apparatus 102. The information shows that making the access to the electronic bulletin board necessitates the approved and disclosed handle name, the approved and closed full name, and the approved and closed contact address.

At the step 1204, it is checked whether or not the sending-party ticket 308 has been attached to the above-described received sent-out contents. If the sending-party ticket 308 has been not attached thereto, the processing goes to a step 1205.

At the step 1205, the response of requesting the transmission of the sending-party ticket 308 is transmitted to the sending-party-side processing apparatus 101. At a step 1206, the sending-party ticket 308 is received from the sending-party-side processing apparatus 101. Then, the processing goes to a step 1207.

At the step 1207, a comparison is made between the information included in the sending-party ticket 308 and the information needed for the access and indicated in the provider access policy information 408, thereby checking whether or not the information included in the sending-party ticket 308 satisfies the condition indicated in the provider access policy information 408. If the necessary condition is satisfied, the processing goes to a step 1208. In the example of the sending-party ticket 308 illustrated in FIG. 11, since the approved and disclosed handle name, the approved and closed full name, and the approved and closed contact address have been stored, the necessary condition is judged to be satisfied.

At the step 1208, the above-described received sent-out contents and the ticket ID of the sending-party ticket 308 are stored into the sent-out content managing DB 409 in a state of being caused to correspond to each other. At a step 1209, after the handle name included in the sending-party ticket 308 has been added to the sent-out contents, the sent-out contents are stored into the area of the electronic bulletin board or the home page that is freely browse-capable via the networks.

FIG. 14 is a diagram for illustrating one example of the sent-out content managing DB 409 in the present embodiment. As illustrated in FIG. 14, the sent-out content managing DB 409 in the provider-side processing apparatus 102 has managed the sent-out contents and the ticket ID in a state of being caused to correspond to each other, the sent-out contents having been transmitted from the sending-party-side processing apparatus 101 and having become freely browse-capable, the ticket ID being the ticket information for identifying the sending-party who has transmitted the sent-out contents to the provider-side processing apparatus 102.

Hereinafter, the explanation will be given below concerning the following processing. In the personal information managing system in the present embodiment, when a dispute has occurred by the information such as a libel or a slander included in the sent-out contents that have become freely browse-capable at the provider-side processing apparatus 102, the dispute resolution is supported while simultaneously protecting the personal information on the immediately-concerned-parties.

As having been described earlier, when the sent-out contents are transmitted from the sending-party-side processing apparatus 101 to the provider-side processing apparatus 102, and are stored into the area of an electronic bulletin board or a home page inside the provider-side processing apparatus 102, the sent-out contents are brought into the state of being freely browse-capable via the networks. Moreover, if a user has browsed the sent-out contents publicized on the electronic bulletin board or the home page, and have found out the information such as a libel or a slander toward the user, the user requests the alternative dispute resolving institution to execute the deliberation as to whether or not the sent-out contents include an illegality.

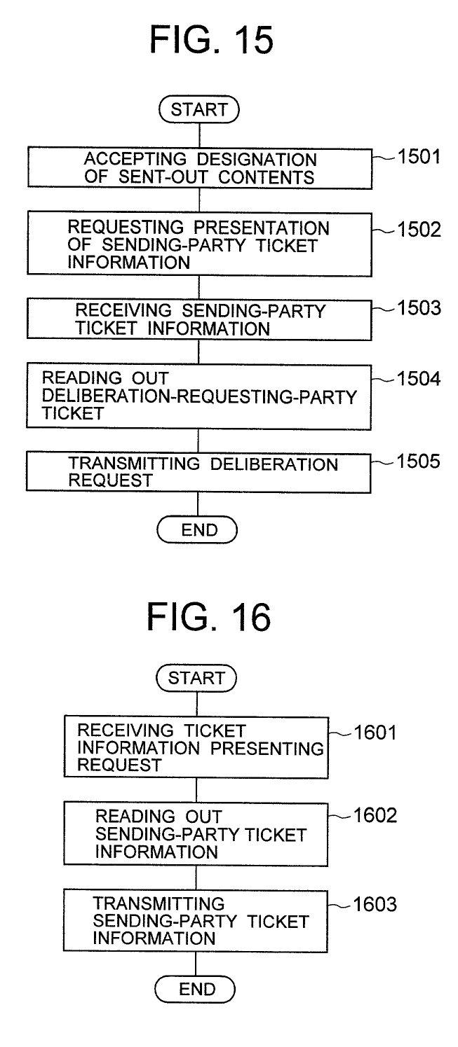

FIG. 15 is a flow chart for illustrating the processing steps of the deliberation requesting process in the present embodiment. As illustrated in FIG. 15, the deliberation requesting process unit 611 in the deliberation-requesting-party-side processing apparatus 104 requests the deliberation support processing apparatus 100 to execute the deliberation as to whether or not the sent-out contents include the illegality together with the ticket information in the sending-party ticket 308 corresponding to the sent-out contents and the deliberation-requesting-party ticket 608. The ticket information presentation requesting process unit 612 requests the provider-side processing apparatus 102 to present the ticket information in the sending-party ticket 308 corresponding to the sent-out contents.

At a step 1501, the deliberation requesting process unit 611 in the deliberation-requesting-party-side processing apparatus 104 accepts the designation of the sent-out contents becoming the target of the deliberation request, from the deliberation-requesting-party. Then, the processing goes to a step 1502.

At the step 1502, the ticket information presentation requesting process unit 612 requests the provider-side processing apparatus 102 to present the ticket information in the sending-party ticket 308 corresponding to the above-described designated sent-out contents.

FIG. 16 is a flow chart for illustrating the processing steps of the ticket information presenting process in the present embodiment. As illustrated in FIG. 16, the ticket information presenting process unit 412 in the provider-side processing apparatus 102 accepts the presentation request for the ticket information on the sent-out contents, which have become freely browse-capable on the electronic bulletin board or the home page, from the deliberation-requesting-party-side processing apparatus 104, and reads out the ticket information corresponding to the sent-out contents from the sent-out content managing DB 409 so as to present the ticket information to the deliberation-requesting-party-side processing apparatus 104.

At a step 1601, the ticket information presenting process unit 412 in the provider-side processing apparatus 102 receives the presentation request for the ticket information from the deliberation-requesting-party-side processing apparatus 104. Then, the processing goes to a step 1602. At the step 1602, the sent-out content managing DB 409 is retrieved to read out the ticket ID corresponding to the sent-out contents designated by the above-described presentation request, from the sent-out content managing DB 409. At a step 1603, as the ticket information corresponding to the sent-out contents designated by the presentation request, the above-described read-out ticket ID is transmitted to the deliberation-requesting-party-side processing apparatus 104 (i.e., the requesting source).

At a step 1503 illustrated in FIG. 15, the ticket information presentation requesting process unit 612 in the deliberation-requesting-party-side processing apparatus 104 receives the ticket ID, which is the requested ticket information in the sending-party ticket 308, from the provider-side processing apparatus 102. Then, the processing goes to a step 1504.

At the step 1504, the deliberation requesting process unit 611 reads out the deliberation-requesting-party ticket 608 stored in the magnetic disk apparatus 603 in the deliberation-requesting-party-side processing apparatus 104. Here, the deliberation-requesting-party ticket 608 (i.e., the ticket of the deliberation-requesting-party) has stored the information such as the ticket ID for identifying the personal information on the deliberation-requesting-party and the handle name of the deliberation-requesting-party. In addition, it is assumed that the deliberation-requesting-party ticket has been acquired in advance in much the same way as the case where the sending-party has acquired the sending-party ticket 308.

At a step 1505, the sent-out contents becoming the target of the deliberation and the ticket information in the sending-party ticket 308 corresponding to the sent-out contents with the deliberation-requesting-party ticket 608 attached thereto are transmitted to the deliberation support processing apparatus 100, thereby requesting the alternative dispute resolving institution to execute the deliberation about the sent-out contents.

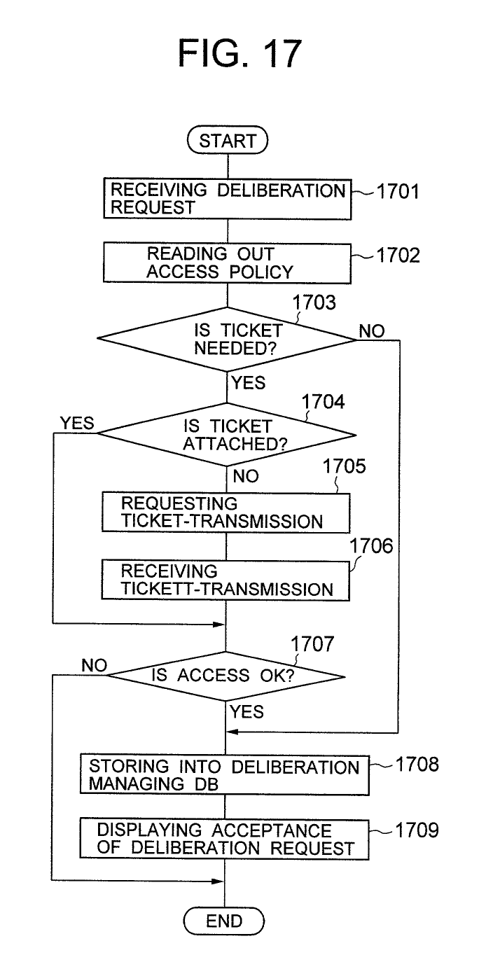

FIG. 17 is a flow chart for illustrating the processing steps of the deliberation accepting process in the present embodiment. As illustrated in FIG. 17, the deliberation accepting process unit 211 in the deliberation support processing apparatus 100 receives the sent-out contents becoming the target of the deliberation, the ticket information in the sending-party ticket 308, and the deliberation-requesting-party ticket 608 from the deliberation-requesting-party-side processing apparatus 104, and accepts the deliberation request.

At a step 1701, the deliberation accepting process unit 211 in the deliberation support processing apparatus 100 receives the sent-out contents becoming the target of the deliberation, the ticket information in the sending-party ticket 308, and the deliberation request including the deliberation-requesting-party ticket 608, from the deliberation-requesting-party-side processing apparatus 104 via the networks. Then, the processing goes to a step 1702.

At the step 1702, the deliberation-supporting access policy information 208 stored in the magnetic disk apparatus 203 in the deliberation support processing apparatus 100 is read out. At a step 1703, it is checked whether or not the deliberation-supporting access policy information 208 has indicated that the deliberation-requesting-party ticket 608 is needed when the deliberation-requesting-party performs the deliberation request toward the deliberation support processing apparatus 100. If the deliberation-requesting-party ticket 608 is needed, the processing goes to a step 1704.

At the step 1704, it is checked whether or not the deliberation-requesting-party ticket 608 has been attached to the above-described received sent-out contents. If the deliberation-requesting-party ticket 608 has been not attached to the sent-out contents, the processing goes to a step 1705.

At the step 1705, the response of requesting the transmission of the deliberation-requesting-party ticket 608 is transmitted to the deliberation-requesting-party-side processing apparatus 104. At a step 1706, the deliberation-requesting-party ticket 608 is received from the deliberation-requesting-party-side processing apparatus 104. Then, the processing goes to a step 1707.

At the step 1707, a comparison is made between the information included in the deliberation-requesting-party ticket 608 and the information needed for the access and indicated in the deliberation-supporting access policy information 208, thereby checking whether or not the information included in the deliberation-requesting-party ticket 608 satisfies the condition indicated in the deliberation-supporting access policy information 208. If the necessary condition is satisfied, the processing goes to a step 1708. Here, as the deliberation-supporting access policy information 208, the following information are defined as necessary information. That is, the approved and closed full name and contact address, and the information for confirming that the deliberation-requesting-party is surely the dispute-immediately concerned-party who is the aggrieved-party suffering from the above-described sent-out contents.

At the step 1708, the above-described received sent-out contents, the ticket information in the sending-party ticket 308, and the ticket information in the deliberation-requesting-party ticket 608 are stored into the deliberation managing DB 209. At a step 1709, a message for indicating the acceptance of the deliberation request is displayed on the output apparatus 205, thereby informing the party-in-charge that the acceptance of the new deliberation request has been performed.

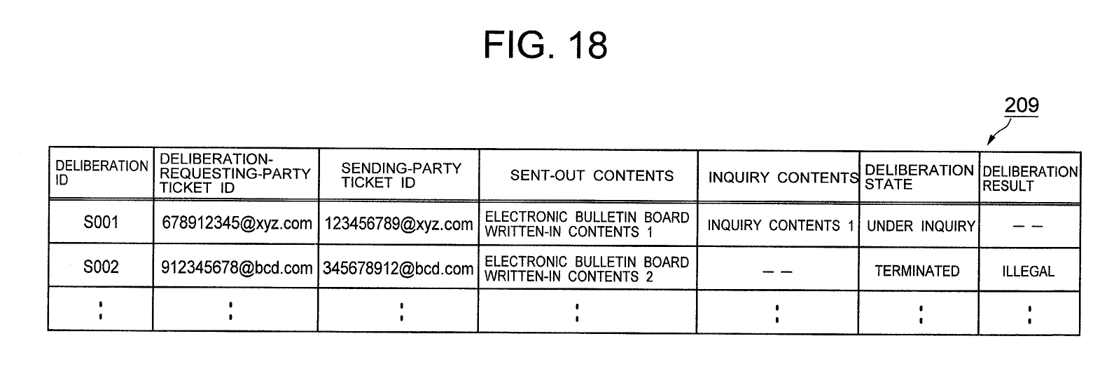

FIG. 18 is a diagram for illustrating one example of the deliberation managing DB 209 in the present embodiment. As illustrated in FIG. 18, the deliberation managing DB 209 in the deliberation support processing apparatus 100 has stored the information for indicating the contents of the deliberation accepted from the deliberation-requesting-party-side processing apparatus 104.

As having been described earlier, when the deliberation request is transmitted from the deliberation-requesting-party-side processing apparatus 104 to the deliberation support processing apparatus 100 and is stored into the deliberation managing DB 209 in the deliberation support processing apparatus 100, the deliberation as to whether or not the sent-out contents include an illegality is executed. If the necessity for making an inquiry of the dispute-immediately-concerned-parties occurs in accompaniment with the development of the deliberation, the inquiry is made using the ticket information stored into the deliberation managing DB 209.

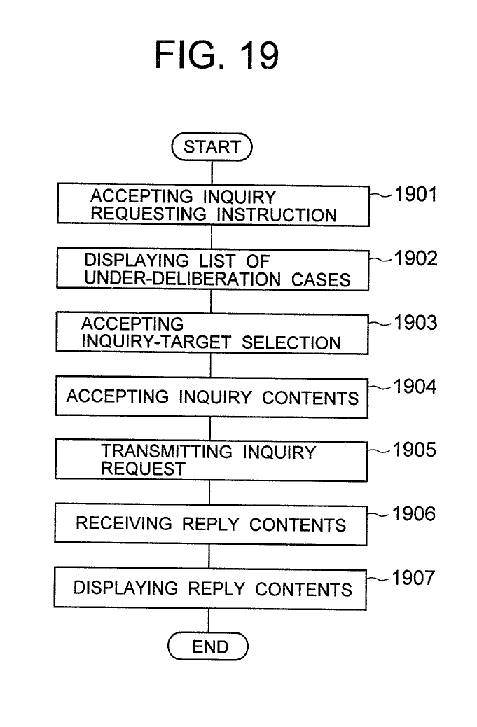

FIG. 19 is a flow chart for illustrating the processing steps of the inquiry requesting process in the present embodiment. As illustrated in FIG. 19, the inquiry requesting process unit 212 in the deliberation support processing apparatus 100 requests the ticket management processing apparatus 103 to make the inquiry to be made of the dispute-immediately-concerned-parties together with the ticket information on the dispute-immediately-concerned-parties, the inquiry accompanying the development of the above-described requested deliberation.

At a step 1901, when an inquiry requesting instruction to be made of the sending-party or the deliberation-requesting-party is inputted in accompaniment with the development of the deliberation, the inquiry requesting process unit 212 in the deliberation support processing apparatus 100 accepts the instruction. Then, the processing goes to a step 1902.

At the step 1902, reference is made to the deliberation managing DB 209, thereby displaying the list of under-deliberation cases on the output apparatus 205. At a step 1903, an input is accepted which indicates to which of the cases the inquiry relates, or whether the inquiry has been made of either the sending-party or the deliberation-requesting-party or the inquiry has been made of both of them.

At a step 1904, the input of the inquiry contents is accepted. At a step 1905, the above-described accepted inquiry contents to which the ticket ID (i.e., the ticket information on the sending-party or the deliberation-requesting-party designated at the step 1903) is attached is transmitted to the ticket management processing apparatus 103 via the networks, thereby requesting the ticket management processing apparatus 103 to make the inquiry to be made of the sending-party or the deliberation-requesting-party.

At a step 1906, a reply to the above-described requested inquiry is received from the ticket management processing apparatus 103 via the networks so as to be stored into the deliberation managing DB 209. At a step 1907, the reply contents are displayed on the output apparatus 205, thereby informing the party-in-charge of the reply content.

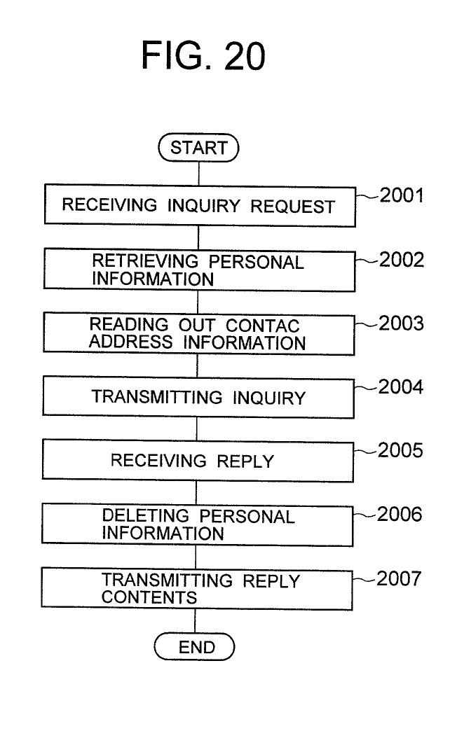

FIG. 20 is a flow chart for illustrating the processing steps of the inquiring process in the present embodiment. As illustrated in FIG. 20, the inquiring process unit 513 in the ticket management processing apparatus 103 accepts the inquiry request to be made of the dispute-immediately-concerned-parties from the deliberation support processing apparatus 100, makes reference to the personal information on the dispute-immediately-concerned-parties identified by the ticket information transmitted together with the inquiry request, and makes the above-described requested inquiry of a contact address included in the above-described personal information to which the reference has been made.

At a step 2001, the inquiring process unit 513 in the ticket management processing apparatus 103 receives the inquiry request to be made of the sending-party or the deliberation-requesting-party, from the deliberation support processing apparatus 100 via the networks. Then, the processing goes to a step 2002.

At the step 2002, the personal information DB 509 is retrieved using the ticket ID (i.e., the ticket information transmitted together with the inquiry request). At a step 2003, the contact address information such as a mail address of the sending-party or the deliberation-requesting-party is read out from a record of the above-described retrieved personal information. At a step 2004, the inquiry contents received at the step 2001 are transmitted to the above-described read-out mail address by an electronic mail, thereby making the inquiry to be made of the sending-party or the deliberation-requesting-party.

At a step 2005, a reply to the above-described made inquiry is received from the sending-party or the deliberation-requesting-party by an electronic mail. At a step 2006, the mail address of the sending-party or the deliberation-requesting-party is deleted from a header of the above-described electronic mail. After that, at a step 2007, the reply from the sending-party or the deliberation-requesting-party is transmitted to the deliberation support processing apparatus 100 that has performed the inquiry request.

As having been described earlier, if the necessity for making the inquiry of the dispute-immediately-concerned-parties occurs in accompaniment with the development of the deliberation, the deliberation support processing apparatus 100 in the present embodiment requests the ticket management processing apparatus 103 to make the inquiry with the use of the ticket information on the dispute-immediately-concerned-parties stored into the deliberation managing DB 209. This condition allows the inquiry necessary for the deliberation to be made with the personal information on the dispute-immediately-concerned-parties kept closed.

As having been described earlier, if the deliberation has been executed and terminated, and the sent-out contents is judged to include the illegality, the deliberation support processing apparatus 100 requests the ticket management processing apparatus 103 to present the personal information identified by the ticket information on the dispute-immediately-concerned-parties. Thereby, the personal information on the sending-party is disclosed and a resolving-proposal for the dispute is presented.

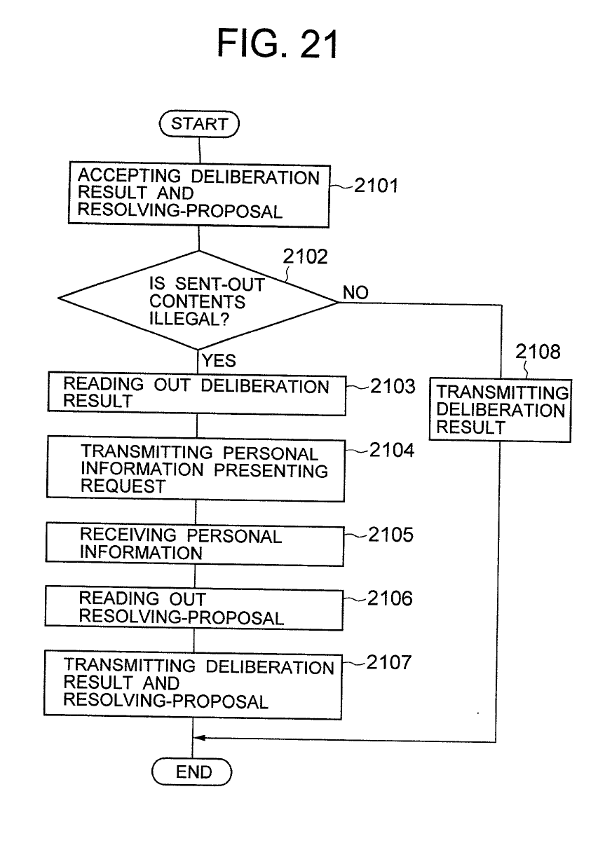

FIG. 21 is a flow chart for illustrating the processing steps of the deliberation result informing process in the present embodiment. As illustrated in FIG. 21, the deliberation result informing process unit 213 in the deliberation support processing apparatus 100 discloses the personal information on the sending-party to the deliberation-requesting-party in accordance with the result of the requested deliberation, and presents the resolving-proposal for the dispute, which is caused by the sent-out contents, to the dispute-immediately-concerned-parties. If the sent-out contents have been judged to be illegal by the requested deliberation, the personal information presentation requesting process unit 214 requests the ticket management processing apparatus 103 to present the personal information on the sending-party or the deliberation-requesting-party identified by the ticket information in the sending-party ticket 308 and the deliberation-requesting-party ticket 608.

At a step 2101, when the deliberation about the sent-out contents has been terminated and the input of the deliberation result and the resolving-proposal has been performed, the deliberation result informing process unit 213 in the deliberation support processing apparatus 100 accepts the input of the deliberation result and the resolving-proposal so as to store them into the deliberation managing DB 209 in the magnetic disk apparatus 203. Then, the processing goes to a step 2102.

At the step 2102, it is checked whether or not the above-described inputted deliberation result has indicated that the sent-out contents include the illegality. If the sent-out contents have been judged to be illegal, the processing goes to a step 2103.

At the step 2103, the personal information presentation requesting process unit 214 reads out the deliberation result indicating that the sent-out contents are illegal, and the ticket ID (i.e., the ticket information on the sending-party and the deliberation-requesting-party), from the deliberation managing DB 209.

At a step 2104, after adding the ticket ID of the sending-party and that of the deliberation-requesting-party to the above-described read-out deliberation result, the deliberation-responsible-party ticket 210 of the deliberation-responsible-party who has performed the deliberation is attached to the read-out deliberation result. Then, the read-out deliberation result is transmitted to the ticket management processing apparatus 103 via the networks, thereby requesting the ticket management processing apparatus 103 to present the personal information on the sending-party or the deliberation-requesting-party.

At a step 2105, the requested personal information on the sending-party and the deliberation-requesting-party is received from the ticket management processing apparatus 103 via the networks. At a step 2106, the above-described resolving-proposal is read out from the deliberation managing DB 209. At a step 2107, the deliberation result, the background of the sending-party, and the resolving-proposal are transmitted to the contact address such as the mail address indicated in the personal information on the deliberation-requesting-party, and the resolving-proposal is transmitted to the contact address such as the mail address indicated in the personal information on the sending-party, thereby proposing the resolution of the dispute.

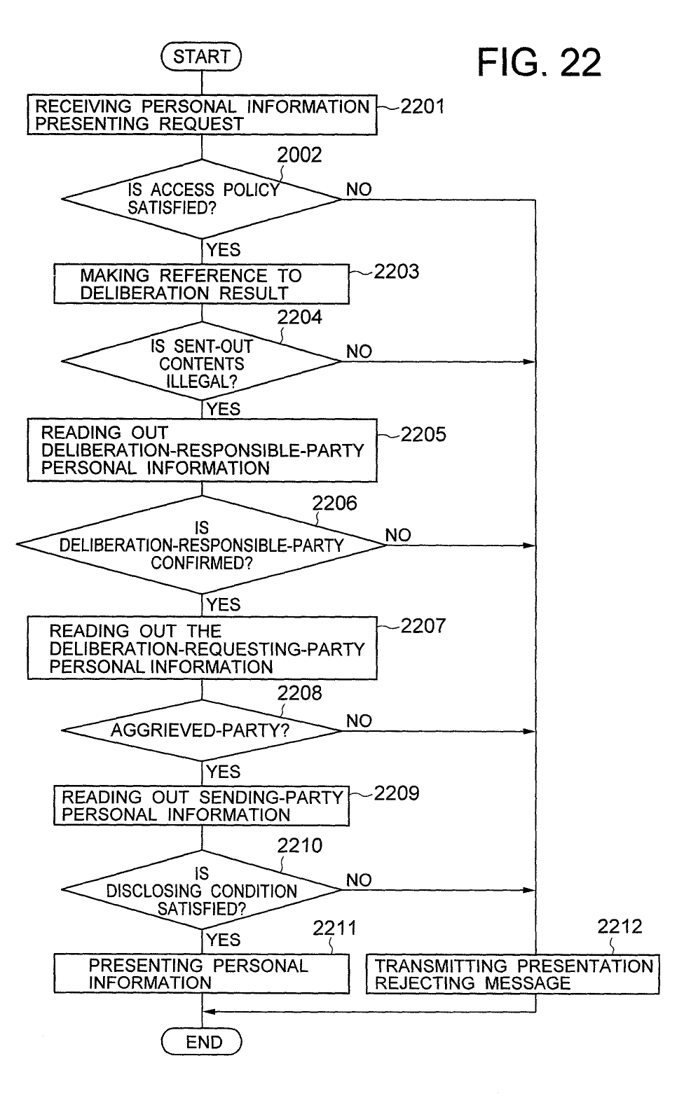

FIG. 22 is a flow chart for illustrating the processing steps of the personal information presenting process in the present embodiment. As illustrated in FIG. 22, the personal information presenting process unit 514 in the ticket management processing apparatus 103 accepts the presentation request for the personal information from the deliberation support processing apparatus 100 satisfying the condition in the personal information access policy information 508, and presents the personal information on the dispute-immediately-concerned-parties identified by the ticket information transmitted together with the above-described presentation request, to the deliberation support processing apparatus 100.

At a step 2201, the personal information presenting process unit 514 in the ticket management processing apparatus 103 receives the presentation request for the personal information including the deliberation result, the ticket information on the sending-party and the deliberation-requesting-party, and the deliberation-responsible-party ticket 210, from the deliberation support processing apparatus 100 via the networks. Then, the processing goes to a step 2202.

At the step 2202, a comparison is made between the information included in the above-described received deliberation-responsible-party ticket 210 and the information needed for the presentation request indicated in the personal information access policy information 508, thereby checking whether or not the information included in the deliberation-responsible-party ticket 210 satisfies the condition indicated in the personal information access policy information 508. If the necessary condition is satisfied, the processing goes to a step 2203. If the necessary condition is not satisfied, the processing goes to a step 2212. Here, as the personal information access policy information 508, the following information are defined as necessary information. That is, the approved and closed full name and contact address, and the approved and closed occupation for confirming that the presentation-requesting-party for the personal information is surely the deliberation-responsible-party of the alternative dispute resolving institution submitted the deliberation result.

At the step 2203, reference is made to the contents of the above-described received deliberation result. At a step 2204, it is checked whether or not the above-described deliberation result to which the reference has been made has indicated the illegality of the sent-out contents. If the deliberation result has indicated the illegality of the sent-out contents, the processing goes to a step 2205. If not, the processing goes to the step 2212.

At the step 2205, the personal information corresponding to the ticket ID of the above-described received deliberation-responsible-party ticket 210 is read out from the personal information DB 509. At a step 2206, it is checked whether or not the occupation in the above-described read-out personal information has indicated the deliberation-responsible-party of the alternative dispute resolving institution submitted the deliberation result. If the occupation indicated by the deliberation-responsible-party ticket 210 is the above-described deliberation-responsible-party, the processing goes to a step 2207. If not, the processing goes to the step 2212.

At the step 2207, the personal information corresponding to the ticket ID received as the ticket information on the deliberation-requesting-party is read out from the personal information DB 509. At a step 2208, it is checked whether or not the above-described read-out personal information coincides with the aggrieved-party indicated in the deliberation result. If the personal information coincides with the aggrieved-party, the processing goes to a step 2209. If not, the processing goes to the step 2212. Here, a family member, a concerned-party, or the like other than the aggrieved-party in person is also included in and defined as the deliberation-requesting-party. Accordingly, in the case as well where the deliberation-requesting-party is the family member or the concerned-party of the aggrieved-party, it may be assumed that the processing goes to the step 2209.

At the step 2209, the personal information corresponding to the ticket ID received as the ticket information on the sending-party is read out from the personal information DB 509. At a step 2210, it is checked whether or not the above-described read-out personal information satisfies a disclosing condition for the personal information. If the disclosing condition for the personal information is satisfied, the processing goes to a step 2211. If not, the processing goes to the step 2212. Here, the disclosing condition for the personal information is, for example, a condition for judging whether or not the sending-party (i.e., the assaulting-party) is of an age at which the Juvenile Act is inapplicable, or whether or not the sending-party is in a physical state of having a responsibility-assuming capability. Incidentally, a condition other than the age or the responsibility-assuming capability may be included in and defined as the disclosing condition.

At the step 2211, the above-described read-out personal information on the sending-party and the deliberation-requesting-party is transmitted to the deliberation support processing apparatus 100 (i.e., the presentation requesting source). Also, at the step 2212, a message for indicating that the presentation of the personal information has been not permitted is transmitted to the deliberation support processing apparatus 100 (i.e., the presentation requesting source).

As having been described earlier, in the present embodiment, the deliberation result transmitted as the consequence of the presentation request for the personal information has indicated the illegality of the sent-out contents. Moreover, the party who has made the presentation request is the deliberation-responsible-party of the alternative dispute resolving institution that has submitted the deliberation result, and the deliberation-requesting-party is the aggrieved-party in person. Furthermore, the presentation of the personal information is executed in the case where the age or the responsibility-assuming capability of the sending-party satisfies the disclosing condition for the personal information. This allows the dispute resolution to be supported while simultaneously protecting the personal information on the immediately-concerned-parties.

As having been described earlier, the present embodiment makes it possible to execute, on the condition of the anonymity, the deliberation about the sent-out contents sent out from the information processing apparatus. As a consequence, the provider owning the personal information on the sending-party need not make the judgement on whether the disclosure of the personal information on the sending-party is appropriate or inappropriate, and the alternative dispute resolution system provides the simplified and high-reliability dispute resolution. This makes it possible to decrease the silent-resignation no-lawsuit-filing cases. Also, as long as there exists no illegality in the deed, the personal information is closed. This prevents the personal revenge and decreases the risks between the immediately-concerned-parties, thereby making it possible to promote the utilization of the alternative dispute resolution system.

As having been described so far, the personal information managing system in the present embodiment supports the deliberation for the dispute resolution where the personal information on the dispute-immediately-concerned-parties has been closed. Accordingly, it becomes possible to decrease the burden on the provider as to whether the disclosure of the personal information is appropriate or inappropriate and the risks between the immediately-concerned-parties, thereby allowing the simplified and high-reliability dispute resolution to be implemented.

The present invention supports the deliberation for the dispute resolution where the personal information on the dispute-immediately-concerned-parties has been closed. Accordingly, it becomes possible to decrease the burden on the provider as to whether the disclosure of the personal information is appropriate or inappropriate and the risks between the immediately-concerned-parties, thereby allowing the simplified and high-reliability dispute resolution to be implemented.

What is claimed is:

1. A personal information managing method in a case of resolving a dispute occurred by information sent out from an information processing apparatus, comprising the steps of:
accepting an input for designating sent-out contents capable of being browsed on a provider-side processing apparatus connected via a network;
receiving ticket information for identifying a sending-party sending out said designated sent-out contents, from said provider-side processing apparatus;
transmitting said sent-out contents and said ticket information from a deliberation-requesting-party-side processing apparatus to a deliberation support processing apparatus to request a deliberation about said sent-out contents;
receiving said sent-out contents and said ticket information from said deliberation-requesting-party-side processing apparatus to store said sent-out contents and said ticket information into a deliberation managing database in said deliberation support processing apparatus, said sent-out contents becoming a target of said deliberation;
accepting an input of a deliberation result of said requested deliberation to store said deliberation result into said deliberation managing database;
transmitting said ticket information stored in said deliberation managing database, from said deliberation support processing apparatus to a ticket management processing apparatus;
requesting presentation of personal information on said sending-party;
receiving said ticket information from said deliberation support processing apparatus;
transmitting said personal information on said sending-party identified by said ticket information, from said ticket management processing apparatus to said deliberation support processing apparatus; and
transmitting said deliberation result stored in said deliberation managing database and said personal information on said sending-party received from said ticket management processing apparatus, from said deliberation support processing apparatus to said deliberation-requesting-party-side processing apparatus.

2. A personal information managing method as claimed in claim 1, further comprising the steps of:
accepting an input of inquiry contents toward said sending-party to store said inquiry contents into said deliberation managing database;
transmitting said inquiry contents and said ticket information stored in said deliberation managing database, from said deliberation support processing apparatus to said ticket management processing apparatus;
receiving said inquiry contents and said ticket information from said deliberation support processing apparatus;
making reference to a mail address indicated by a contact address included in said personal information identified by said ticket information; and
transmitting said inquiry contents from said ticket management processing apparatus to said mail address.

3. A personal information managing method as claimed in claim 1, further comprising the steps of:
receiving said deliberation result and said ticket information stored in said deliberation managing database, from said deliberation support processing apparatus; and
transmitting said personal information on said sending-party identified by said ticket information, from said ticket management processing apparatus to said deliberation support processing apparatus, when said deliberation result indicates that said sent-out contents include an illegality.

4. A personal information managing method as claimed in claim 2, further comprising the steps of:
receiving said deliberation result and said ticket information stored in said deliberation managing database, from said deliberation support processing apparatus; and
transmitting said personal information on said sending-party identified by said ticket information, from said ticket management processing apparatus to said deliberation support processing apparatus, when said deliberation result indicates that said sent-out contents include an illegality.

5. A personal information managing system in a case of resolving a dispute occurred by information sent out from an information processing apparatus, comprising:
a deliberation requesting process unit for accepting an input for designating sent-out contents capable of being browsed on a provider-side processing apparatus connected via a network, for receiving ticket information for identifying a sending-party sending out said designated sent-out contents, from said provider-side processing apparatus, and for transmitting said sent-out contents and said ticket information from a deliberation-requesting-party-side processing apparatus to a deliberation support processing apparatus to request a deliberation about said sent-out contents;
a deliberation accepting process unit for receiving said sent-out contents and said ticket information from said deliberation-requesting-party-side processing apparatus to store said sent-out contents and said ticket information into a deliberation managing database in said deliberation support processing apparatus, said sent-out contents becoming a target of said deliberation;
a personal information presentation requesting process unit for accepting an input of a deliberation result of said requested deliberation to store said deliberation result into said deliberation managing database, for transmitting said ticket information stored in said deliberation managing database, from said deliberation support processing apparatus to a ticket management processing apparatus, and for requesting presentation of personal information on said sending-party;
a personal information presenting process unit for receiving said ticket information from said deliberation support processing apparatus, and for transmitting said personal information on said sending-party identified by said ticket information, from said ticket management processing apparatus to said deliberation support processing apparatus; and
a deliberation result informing process unit for transmitting said deliberation result stored in said deliberation managing database and said personal information on said sending-party received from said ticket management processing apparatus, from said deliberation support processing apparatus to said deliberation-requesting-party-side processing apparatus.

6. A computer-readable record medium that records a program for causing a computer to function as a deliberation support processing apparatus for resolving a dispute occurred by information sent out from an information processing apparatus, said computer-readable record medium recording said program for causing said computer to function as:
a deliberation accepting process unit for receiving sent-out contents becoming a target of said deliberation and ticket information from a deliberation-requesting-party-side processing apparatus to store said sent-out contents and said ticket information into a deliberation managing database in said deliberation support processing apparatus;
a personal information presentation requesting process unit for accepting an input of a deliberation result of said requested deliberation to store said deliberation result into said deliberation managing database, for transmitting said ticket information stored in said deliberation managing database, from said deliberation support processing apparatus to a ticket management processing apparatus, and for requesting presentation of personal information on a sending-party; and
a deliberation result informing process unit for transmitting said deliberation result stored in said deliberation managing database and said personal information on said sending-party received from said ticket management processing apparatus, from said deliberation support processing apparatus to said deliberation-requesting-party-side processing apparatus.

7. An information processing apparatus for providing sent-out information via a network, comprising:
information-sending accepting process means for accepting said sent-out information provided from said information processing apparatus for sending out said information, and for causing another information processing apparatus to make an access to said sent-out information via said network;
individual-identification-information presenting process means for processing information for identifying a sending-party of said information;
means for storing provider access policy information that is information for permitting said another information processing apparatus to make said access to said sent-out information; and
sent-out content managing record means for recording said accepted sent-out information and said sending-party identification information in a state of being caused to be related to each other.

8. An information processing apparatus as claimed in claim 7, wherein:
said sent-out information is any one of text data, image data, motion-picture data, and voice data; and
said information-sending accepting process means accepts said sent-out information and uploads said sent-out information onto an electronic bulletin board or a home page.

9. A deliberation support processing apparatus for deliberating a dispute resolution in a case of resolving a dispute occurred by information sent out from an information processing apparatus, comprising:
deliberation accepting process means for receiving sent-out contents becoming a target of said deliberation, identification information on a sending-party, and identification information on a deliberation-requesting-party, and for accepting a deliberation request to be stored into deliberation-managing-information storing means;
inquiry requesting process means for processing information about which an inquiry is to be made of immediately-concerned-parties of said dispute for said deliberation;
deliberation result informing process means for transmitting a deliberation result stored in said deliberation-managing-information storing means and personal information on said sending-party to an information processing apparatus in which said deliberation request is made; and
personal information presentation requesting process means for accepting said result of said requested deliberation, for transmitting, to an individual-identification-information managing process apparatus, said individual-identification-information stored in said deliberation-managing-information storing means, and for requesting presentation of said personal information on said sending-party.

10. A deliberation support processing apparatus as claimed in claim 9, said deliberation support processing apparatus having record means for storing, as deliberation-supporting access policy information, a condition for permitting said acceptance of said deliberation request at said deliberation accepting process means.

11. An information processing apparatus for sending out information, comprising:
personal information registration requesting process means for requesting an individual-identification-information managing process apparatus to register personal information on a sending-party sending out said information;
information-sending process means for accepting said information on sent-out contents, and for transmitting said sent-out information to a sent-out information browsing apparatus for causing another information processing apparatus to make an access to said sent-out information; and
access requesting process means for acquiring sending-party-identification-information for making an access from said individual-identification-information managing process apparatus to said sent-out information browsing apparatus, and for transmitting said information on sent-out contents and said sending-party-identification-information to said sent-out information browsing apparatus.

12. An individual-identification-information managing process apparatus, comprising:
personal information registering process means for accepting a registration request for personal information from an information processing apparatus sending out information, and for registering said personal information into personal information recording means for storing said personal information;
individual-identification-information issuing process means for accepting an issuing request from a user registering said personal information, and for issuing individual-identification-information on said user;
inquiring process means for receiving inquiry contents and said individual-identification-information from a deliberation support processing apparatus, and for transmitting said inquiry contents to said user based on said individual-identification-information; and
personal information presenting process means for transmitting, to said deliberation support processing apparatus, said personal information on said information sending-party identified by said individual-identification-information received from said deliberation support processing apparatus.

13. An information processing apparatus for requesting a deliberation request for a dispute, comprising:
deliberation requesting process means for inputting information on sent-out contents capable of being browsed from an information browsing apparatus, for inputting, from said information browsing apparatus, identification information for identifying a sending-party sending out designated sent-out contents, and for transmitting said information on said sent-out contents and said identification information to a deliberation support processing apparatus to request a deliberation about said sent-out contents; and
individual-identification-information presentation requesting process means for requesting said information browsing apparatus to present said sending-party-identification-information corresponding to said sent-out contents.
